(19) United States
(12) Patent Application Publication
(10) Pub. No.: US 2004/0196802 A1
(43) Pub. Date: Oct. 7, 2004

(54) Apparatus and method for controlling reverse link data rate of packet data in mobile communication system

(75) Inventors: Beom-Sik Bae, Suwon-si (KR); Dae-Gyun Kim, Soongnam-si (KR); Jung-Soo Jung, Seoul (KR)

Correspondence Address: DILWORTH & BARRESE, LLP, 333 EARLE OVINGTON BLVD., UNIONDALE, NY, 11553, US

(73) Assignee: SAMSUNG ELECTRONICS CO., LTD., GYEONGGI-DO (KR)

(21) Appl. No.: 10/817,087

(22) Filed: Apr. 2, 2004

(30) Foreign Application Priority Data
Apr. 2, 2003 (KR) P2003-20880

(51) Int. Cl. H04B 7/216

(52) U.S. Cl. 370/328

(57) ABSTRACT

Disclosed is an apparatus and method for controlling a reverse link data rate of packet data in a mobile communication system. There is provided an apparatus and method for controlling a reverse data rate of packet data taking into consideration the state of a mobile terminal, which is capable of sufficiently using reverse capacity and adjusting for a sudden variation of reverse receipt sensitivity and an effect of interference in a mobile communication system. A method for providing information for reverse data rate control of packet data in a mobile terminal of a mobile communication system, comprises the steps of determining and updating the status of reverse data rate control factors of the mobile terminal every predetermined period, and transmitting status report information in a reverse direction over predetermined channels, the status report information based on the updated factors.

### PRIORITY

This application claims priority to an application entitled “APPARATUS AND METHOD FOR CONTROLLING REVERSE LINK DATA RATE OF PACKET DATA IN MOBILE COMMUNICATION SYSTEM”, filed in the Korean Intellectual Property Office on Apr. 2, 2003 and assigned Serial No. 2003-20880, the contents of which are incorporated herein by reference.

### BACKGROUND OF THE INVENTION

1. Field of the Invention

The present invention relates to an apparatus and method for controlling a reverse link data rate in a mobile communication system, and more particularly to an apparatus and method for controlling a reverse link data rate of packet data in a mobile communication system.

2. Description of the Related Art

In general, a mobile communication system has developed from a system for providing only a voice service, to a system for providing a data service together the voice service. With regard to the mobile communication system for providing the data service, improvements have been many studies and developed to increase the information rate to users. Examples of such a mobile communication system providing the data service include a 1× EV-DO (Evolution Data Only) system, a 1× EV-DV (Evolution Voice and Data) system, an HSDPA (High Speed Downlink Packet Access) system, etc. From among these systems, the 1× EV-DO system is currently in commercial use and the 1× EV-DV is expected to come into commercial use shortly. Such systems transmit data in units of packets. There is a need to control the packet data transmission. This is required for both a forward link and a reverse link of a base station.

The term “forward” refers to a transmission direction from a base station to a terminal, and the term “forward” refers to a transmission direction from the terminal to the base station. A forward data rate control is scheduled by taking into consideration the overall capacity of the links of the base station, the amount of data to be provided, the quality of service (QoS), and other similar factors. The base station can control a data rate using an appropriate method. In the reverse link, all mobile terminals may start a reverse transmission at the same time, and the mobile communication system cannot foresee when the reverse data transmission will occur and how much information is to be transmitted. The mobile communication system cannot accurately control the reverse data rate that needs to be performed for many, unspecified mobile terminals.

The forward and reverse data rate control method for use with the 1× EV-DO system will be considered. In the case of the data transmission of the forward link in the 1× EV-DO system, a base station transmits data to only a specific mobile terminal having the best channel state by taking into consideration the condition of the air and other environmental factors so as to maximize data throughput of the mobile terminal. In the data transmission of the reverse link, a plurality of mobile terminals simultaneously access a base station for packet data transmission. The base station is required to perform proper overload control within the capacity of the mobile terminal by controlling flow and congestion of data received from the plurality of mobile terminals.

The data transmission of the reverse link in a CDMA2000 1× EV-DO system is performed using a reverse activity bit (hereinafter, referred to as “RAB”) and a reverse rate limit message transmitted by the base station. In addition, the constantly changing data rate of a mobile terminal is reported to the base station using a reverse rate indicator (RRI). The reverse rate limit message is a signaling message for limiting the data rate of the mobile terminal. The reverse data rate of the mobile terminal cannot exceed the maximal data rate indicated by the reverse rate limit message. The RAB, which represents a degree of congestion of the reverse link, is periodically transmitted to all currently connected mobile terminals.

Since the RAB is broadcast to all mobile terminals, all currently connected mobile terminals in a particular cell (or sector) receive the same RAB. Each mobile terminal adjusts its data rate based on the received RAB. The mobile terminal continuously performs a persistence test based on the RAB received from the base station and a current reverse data rate when the reverse data rate is adjusted. In addition, the mobile terminal increments or decrements the current reverse data rate by one step, or maintains the current reverse data rate, based on a result of the performed persistence test. When controlling the overload of the reverse link and adjusting for the capacity of the reverse link, the base station controls the flow of data from the mobile terminals using the RAB.

As described above, for the reverse data rate control, the 1× EV-DO system broadcasts the RAB to all mobile terminals so that they can uniformly adjust their reverse data rates based on the RAB. If a bit value of the RAB is “up”, reverse data rates of all mobile terminals are incremented or maintained. On the contrary, if a bit value of the RAB is “down”, reverse data rates of all mobile terminals are decremented or maintained. In addition, the mobile terminal performs the persistence test for generating a random number when adjusting the reverse data rate. Accordingly, the reverse data rate is varied based on probabilities and is not constant. It is impossible for the base station to predict the state of a reverse channel and adjust the reverse data rate efficiently based on these random probabilities.

Alternatively, there is a method for separately transmitting the RAB to mobile terminals for the reverse data rate control. A method for transmitting a dedicated RAB has been proposed. This method involves controlling the mobile terminals individually, unlike the 1× EV-DO system where the RAB is broadcasted to all mobile terminals.

In the method that utilizes the dedicated RAB, the RAB is individually transmitted from the base station to each mobile terminal, and each mobile terminal increments or decrements the reverse data rate by one step, or maintains it based on its dedicated RAB. Since using the dedicated RAB allows the base station to individually control mobile terminals based on current reverse load, receipt sensitivity, a scheduling policy, etc., the dedicated RAB can increase reverse performance and scheduling performance, compared to the 1× EV-DO using the common RAB and the persistence test.

However, even in the case of the dedicated RAB, if the mobile terminal has no data to be transmitted or cannot increase the data rate due to its limitation of transmission power, or the reverse data rate of the mobile terminal is controlled by different base stations in a handoff region, the dedicated RAB of the mobile terminal may conflict with a RAB transmitted by another base station.

The mobile terminal must inform the base station of its data rate through a reverse rate indicator channel (hereinafter, referred to as “R-RICH”) such that the base station can receive data transmitted by the mobile terminal. Even when using the dedicated RAB, there is a problem in that the reverse data rate control is performed without taking into consideration the state of the mobile terminal.

In the reverse data rate control methods proposed so far, the mobile terminal controls the reverse data rate and an overall bandwidth of the mobile terminal using only received or measured reverse information. These methods allow a system to control a bandwidth and an overload when the reverse data rate is controlled. However, since the base station cannot predetermine the state of the mobile terminal, there is a problem in that it is difficult for the base station to predict variations in the reverse data rate of the mobile terminal based on the RAB transmitted by the base station. In addition, it is difficult to change the data rate of the mobile terminal by more than one step. This is because multiple stepped variations of the data rate increase interference, which may result in more deterioration of reverse performance of a mobile communication system. Accordingly, in the above-described methods, the RAB of the mobile terminal is generated depending on the channel state and load of the mobile terminal received by the base station.

This in turn leads to a very high possibility of incomplete use of the reverse channel capacity of the base station. In addition, in the above-described methods, since the data rate of the mobile terminal can be controlled only on a step by step basis, there is also a problem in that the variation of the data rate cannot catch up with a sudden variation of the receipt sensitivity of the reverse channel and interference between reverse channels.

### SUMMARY OF THE INVENTION

Therefore, the present invention provides a way to compensate for the above problems, and it is an object of the present invention to provide an apparatus and method for controlling a reverse data rate of packet data, which is capable of sufficiently using the reverse capacity in a mobile communication system.

It is another object of the present invention to provide an apparatus and method for controlling a reverse data rate of packet data, which is capable of adjusting for a sudden variation of reverse receipt sensitivity in a mobile communication system.

It is yet another object of the present invention to provide an apparatus and method for controlling a reverse data rate of packet data, which is capable of compensating for an effect of interference in a mobile communication system.

It is yet another object of the present invention to provide an apparatus and method for controlling a reverse data rate of packet data by taking into consideration the state of a mobile terminal in a mobile communication system.

In accordance with an aspect of the present invention, the above and other objects can be accomplished by providing a method for providing information to control the reverse data rate of packet data in a mobile terminal of a mobile communication system, the method comprising the steps of: a) determining checking and updating the status of reverse data rate control factors of the mobile terminal; and b) transmitting status report information in a reverse direction through predetermined channels, the status report information being configured by the updated factors.

In accordance with another aspect of the present invention, there is provided an apparatus for controlling a reverse packet data rate in a mobile communication system including mobile terminals and base stations, wherein each of the mobile terminals determines and updates the status of reverse data rate control factors of each mobile terminal and transmits status report information in a reverse direction through predetermined channels, the status report information based on the updated factors; and wherein each of the base stations receives the status report information, generates reverse activity information for each mobile terminal based on the received status report information and the state of channels and systems, and transmits the generated reverse activity information to each mobile terminal.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a block diagram of a transmitter for transmitting status report information to R-SRCH in accordance with an embodiment of the present invention;

FIG. 2 is a timing chart of data rate control of a reverse link in accordance with an embodiment of the present invention;

FIG. 3 is a flow chart illustrating a process for changing a reverse data rate at the time of receiving RAB in a mobile communication system in accordance with an embodiment of the present invention; and

FIG. 4 is a flow chart illustrating a process for generating status report information of a mobile terminal and transmitting the information in a reverse direction in accordance with an embodiment of the present invention.

### DETAILED DESCRIPTION OF THE PREFERRED EMBODIMENTS

Now, preferred embodiments of the present invention will be described in detail with reference to the annexed drawings. In the drawings, it should be noted that the same or similar elements are denoted by the same reference numerals even though they are depicted in different drawings.

In the following description made in conjunction with the preferred embodiments of the present invention, a variety of specific terms such as concrete messages or signals are described. The description of such terms is included only for a better understanding of the present invention. Those skilled in the art will appreciate that the present invention can be implemented without using the above-mentioned specific terms. In the following description, a detailed description of known functions and configurations incorporated herein will be omitted when it may obscure the subject matter of the present.

The channels required for a mobile terminal and a base station will now be described. First, a forward-reverse rate control channel (hereinafter, referred to as “F-RRCCH”) is provided. The F-RRCCH transmits RAB for controlling the reverse data rate of the mobile terminal. This RAB has more than one bit so as to control the reverse data rate in multiple steps. Second, a reverse packet data channel (hereinafter, referred to as “R-PDCH”) is provided. The R-PDCH changes a reverse packet data rate based on the RAB transmitted by the base station and the state of the mobile terminal. Third, a reverse rate indicator channel (hereinafter, referred to as “R-RICH”) is provided. The R-RICH, a channel for informing the base station of the data rate transmitted over the R-PDCH, can transmit status report information consisting of a predetermined number of bits representing the state of the mobile terminal in accordance with the present invention. Finally, a reverse status report channel (hereinafter, referred to as “R-SRCH”) is provided. The R-SRCH transmits only information relating to the data rate of the R-RICH. This channel can be used if a channel for transmitting the status report information representing the state of the mobile terminal is separately provided.

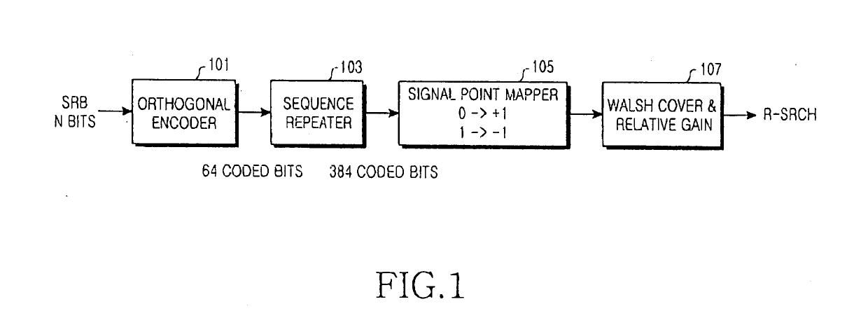

A structure of a transmitter for transmitting the R-SRCH is shown in FIG. 1, which shows a block diagram of the transmitter for transmitting the status report information over the R-SRCH in accordance with the embodiment of the present invention.

The status report information SRB for informing the base station of the state of the mobile terminal is input to an orthogonal encoder 101. The status report information is orthogonally encoded in the orthogonal encoder 101 and output as 64 encoded bits. Here, the 64 encoded bits are employed for the purpose of description only, the number of bits can be varied depending on a transmission rule of each system. The following description will be given using the 64 encoded bits example. The encoded status report information output from the orthogonal encoder 101 is input to a sequence repeater 103.

Based on a predetermined sequence, the sequence repeater 103 repeats six times the encoded status report information consisting of the 64 bits and outputs 384 repeated encoded bits. The repeated status report information is input to a signal point mapper 105. The signal point mapper 105 maps a bit with a “0” value to “+1” information and a bit with a “1” value to “−1” information. The information mapped through such a process is input to a Walsh cover & relative gain controller 107 where the mapped information is multiplied by the gain of channel for Walsh covering and transmission. A result of the multiplication is output to the R-SRCH.

Status Report Information

The mobile terminal transmits the status report information to the base station every frame. The content of the status report information can be updated for each transmission period and can have an update period longer than the transmission period. The same status report information is repeated and transmitted within the update period. Alternatively, the status report information can be transmitted non-periodically. In the case of the non-periodical transmission, there are two points of time for the transmission to occur as follows. A first case is when the mobile terminal is required to transmit the status report information. A second case is when the mobile terminal transmits the status report information under the control of the base station. In other cases, a corresponding channel transmitting the status report information is discontinuously transmitted (DTX operation).

The parameters used for the status report information will be described. A first factor used for the status report information is the status of a transmission buffer. The status report information can be transmitted including a buffer indicator. The buffer indicator is generated by measuring the buffer status of the mobile terminal. For example, when the buffer indicator is represented as 1 bit information, the mobile terminal sets the buffer indicator to ‘0’ if the amount of data in the transmission buffer is greater than a threshold value, and to ‘1’ of the amount of data in the transmission buffer is less than a threshold value. The threshold value can be a constant value or can be varied depending on the reverse data rate of the mobile terminal. In addition, although the buffer indicator consists of 1 bit in the above example, it can consist of two or more bits if necessary.

A second factor used for the status report information is a power indicator. The mobile terminal determines a margin of current transmission power and can set and transmit power indicators with different values depending on the presence of the margin. When the power indicator consists of 1 bit, the mobile terminal sets the power indicator to ‘0’ if the reverse data rate can be further increased as a result of the determinator for the margin of the current transmission power, and to ‘1’ of the reverse data rate cannot be increased. Although the power indicator consists of 1 bit in the above example, it can consist of two or more bits if necessary.

A third factor used for the status report information is a rate request indicator. The mobile terminal can request from the base station an increase or decrease of the reverse data rate of the mobile terminal based on a degree of a QoS request and transmission traffic of the mobile terminal. The rate request indicator is used as a value to indicate the increase or decrease request. For example, when the rate request indicator consists of 1 bit, the mobile terminal can set the rate request indicator to ‘0’ if the increase of the reverse data rate is required. If the decrease of the reverse data rate is not required the mobile terminal can set the rate request indicator to ‘1’. Although the rate request indicator consists of 1 bit in the above example, it can consist of two or more bits if necessary.

The three factors mentioned above can each consist of one or more bits. If the factors are to consist of two or more bits, four pieces of information can be represented by two bits for each factor. The four pieces of information can be defined to decrease by one step, maintain, increase by one step, and decrease by two steps. Also, the four pieces of information can be defined to decrease by two steps, decrease by one step, maintain, and increase by one step. Further, the four pieces of information can be defined to decrease by two steps, decrease by one step, increase by one step, and increase by two steps, excluding the maintaining. The four pieces of information can be defined randomly as required.

Each indicator will now be described in full detail.

First, the buffer indicator will now be described. The mobile terminal determines the current status of the buffer to determine whether a data rate should be increased, decreased or maintained in view of a current data rate. If the data rate should be increased or decreased, the mobile terminal determines if such an increase or decrease should be in one step or two steps. Based on this determination, a value corresponding to one of the four pieces of information, which can be represented by two bits, can be selected.

The power indicator consisting of two or more bits will now be described. First, the mobile terminal determines the difference between the power level of the current data rate and a threshold power level usable in the mobile terminal. Then, the mobile terminal determines if the data rate should be increased, decreased or maintained based on the difference between the power level of the current data rate and the threshold power level. If it is determined that the data rate is not to be maintained, the number of steps required for the increase or decrease is decided, and a value corresponding to one of the four pieces of information, which can be represented by two bits, can be selected.

The rate request indicator consisting of two or more bits will now be described. The mobile terminal determines if the data rate should be increased, decreased, or maintained based on a degree of a QoS request . If it is determined that the data rate is not to be maintained, the mobile terminal decides the number of steps required for the increase or decrease, and a value corresponding to one of the four pieces of information, which can be represented by two bits, can be selected. Although each indicator consisting of two bits has been illustrated in the above example, the above-mentioned methods can be equally applied to an indicator consisting of three bits.

A fourth factor used for the status report information is a rate limit indicator. In the 1× EV-DO system, the base station decides the maximum reverse data rate of the mobile terminal and informs the mobile terminal of the maximum reverse data rate when a traffic channel is established between the mobile terminal and the base station. The mobile terminal knows the maximum data rate with which data can be transmitted in the reverse direction. The current reverse data rate limit indicator of the mobile terminal is set to ‘1’ if it is the maximum reverse data rate agreed upon when the traffic channel is established between the base station and the mobile station. However, if the current reverse data rate is less than the maximum reverse data rate, the reverse data rate limit indicator is set to ‘0’. Although the rate limit indicator consists of 1 bit in the above example, it can consist of two or more bits if necessary.

A fifth factor used for the status report information is a multiple control indicator. The mobile terminal can receive different RABs from two or more base stations if it is located in a handoff region. In this case, the mobile terminal sets the multiple control indicator to ‘1’ if it receives different RABs from different base stations and sets the multiple control indicator to ‘0’ if it receives one RAB from one base station or receives the same RAB from different base stations.

An example of the above-described status report information in the base station will now be described. For the purpose of brevity of explanation, two of the above five indicators of the status report information will be exemplified.

The status report information consisting of 2 bits is considered as an example. The status report information can consist of the buffer indicator as the first factor and the power indicator as the second factor. The mobile terminal sets the indicators to respective bit values as shown in the following Table 1. In addition, the status report information is configured by combining the buffer indicator and the power indicator in the methods described earlier.

When the status report information consists of two bits, the status report information can have a combination as shown in Table 1.

TABLE 1

| Status Report | | | |
|---|---|---|---|
| Information (2 bits) | | | |
| Buffer | Power | Relative | Reverse |
| Indicator | Indicator | Priority | Data Rate |
| 0 | 0 | Very High | Increasing, maintaining or decreasing |
| 0 | 1 | High | Maintaining or decreasing |
| 1 | 0 | Medium | Increasing, maintaining or decreasing |
| 1 | 1 | Low | Maintaining or decreasing |

An example where the status report information consisting of two bits as shown in Table 1 is received at the base station will now be described. When the mobile terminal generates and transmits the status report information to the base station, the base station performs scheduling for the mobile terminal using the transmitted status report information. The scheduling for the mobile terminal in the base station is not only based on the status report information as shown in Table 1 but also other information including an amount of interference in the reverse direction, an effect of neighboring cells, network load, QoS for each service, etc. However, in the present invention, the scheduling based on the status report information transmitted by the mobile terminal is focused, and not based on all information.

A relative priority used for the scheduling in Table 1 is a reference used to distinguish between priorities of mobile terminals, only based on the status report information reported by the mobile terminals to the base station, excluding other information. In general, in a scheduling process, a priority of the mobile terminal is determined based on service information of the mobile terminal. In addition, mobile terminals sequentially determines respective RABs as described below.

As shown in Table 1, if the buffer indicator and the power indicator are each ‘0’, this represents a very high priority. In this case, the reverse data rate is preferentially increased in multiple steps if there is a margin of reverse capacity. However, the priority or the increase or decrease of reverse data rate can be changed depending on factors other than the status report information of the mobile terminal. The increase or decrease of reverse data rate in multiple steps will be later described in detail.

In Table 1, if the buffer indicator is ‘0’ and the power indicator is ‘1’, this represents a relatively high priority. In this case, although there is a great deal of data to be transmitted, the reverse data rate cannot be further increased under current reserve power. Accordingly, the base station maintains the data rate in compliance with the situation of the reverse channel.

In addition, in Table 1, if the power indicator is ‘0’ and the buffer indicator is ‘1’, the reverse data rate can be further increased, but has a relatively low priority since the buffer is less than a threshold value.

Finally, in Table 1, if the buffer indicator and the power indicator are each ‘1’, this signifies that there is a small amount of data to be transmitted and the reverse data rate cannot be further increased. Accordingly, the base station maintains the data rate if there is sufficient margin capacity in the reverse link. However, the reverse data rate is preferentially decreased if necessary.

Reverse Activity Bits (RAB)

In the data rate control methods applied to the 1× EV-DO system or the 1× EV-DV system, the RAB consisting of 1 bit or 2 bits, indicates increasing, maintaining or decreasing the data rate. However, when the status report information in accordance with the present invention is used, since the base station can now be informed of the state of the mobile terminal, the base station can widely adjust the reverse data rate of the mobile terminal by using the RAB of two or more bits. This quickly leads to the minimal data rate required for a service being provided to the mobile terminal. In addition, this allows the reverse capacity to be easily changed by adapting the mobile terminal to a variation of the interference.

The use of the RAB in accordance with the present invention will now be described. The base station basically transmits to the mobile terminal the RAB in every frame. The content of the RAB can be updated for each transmission period and can have an update period longer than the transmission period. In this case, the same RAB is repeated and transmitted within the update period.

(1) Example of use of the RAB of 2 bits

When the RAB consists of 2 bits, it can have the following values:

a. ‘00’: increase the reverse data rate by two steps if possible

b. ‘01’: increase the reverse data rate by one step if possible

c. ‘10’: maintain the reverse data rate if possible

d. ‘11’: decrease the reverse data rate if possible

Although the RAB consisting of 2 bits has the “increase of two steps” and the “decrease of one step” in this example, it can have an “increase of one step” and a “decrease of two steps”.

(2) Example of use of the RAB of 3 bits

When the RAB consists of 3 bits, it can have the following values:

a. ‘000’: increase the reverse data rate by four steps if possible

b. ‘001’: increase the reverse data rate by three steps if possible

c. ‘010’: increase the reverse data rate by two steps if possible

d. ‘011’: increase the reverse data rate by one step if possible

e. ‘100’: maintain the reverse data rate if possible

f. ‘101’: decrease the reverse data rate by three steps if possible

g. ‘110’: decrease the reverse data rate by two steps if possible

h. ‘111’: decrease the reverse data rate by one step if possible

Although the RAB consisting of 3 bits has the “increase of four steps” and the “decrease of three steps” in this example, it can have an “increase of three steps” and a “decrease of four steps”.

Data Rate Control

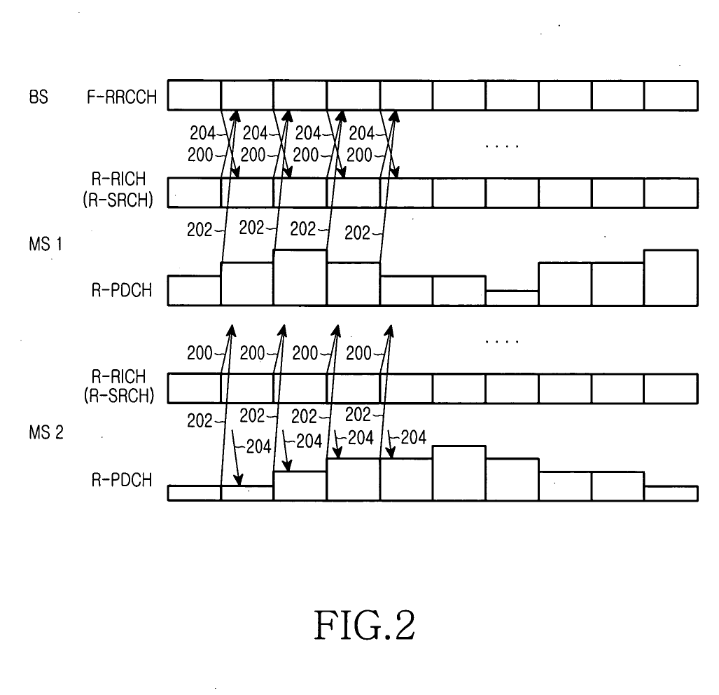

FIG. 2 is a timing chart in data rate control of the reverse link in accordance with an embodiment of the present invention. The data rate control of the reverse link in accordance with the present invention will now be described with reference to FIG. 2. It is shown in FIG. 2 that two mobile terminals NS1 and NS2 transmit data in the reverse direction. It is noted that the data rate control is accomplished in the same way when three or more mobile terminals are present.

Each mobile terminal transmits the reverse data rate information including the status report information to the R-RICH, as indicated by reference numeral 200. Also, at the same point of time, reverse traffic data is transmitted to the R-PDCH, as indicated by reference numeral 202. The reverse traffic data is transmitted during every frame as long as traffic data to be transmitted by the mobile terminals is present. Also, the reverse data rate information including the status report information is transmitted during every frame. The RAB is transmitted every frame through the F-RRCCH to be transmitted in a forward direction. In FIG. 2, reference numeral 204 designates the F-RRCCH during every frame. The RAB is always included in the F-RRCCH.

The status report information is transmitted during every frame and can be updated at a predetermined period. It is assumed in FIG. 2 that an update period of the status report information is one frame. The base station transmits the RAB to each mobile terminal through the F-RRCCH based on the status report information transmitted by the mobile terminals, the reverse receipt sensitivity measured by the base station, network load, the QoS for each service, etc. The RAB is then transmitted to each mobile terminal through one F-RRCCH, with locations of the RAB being distinguished for each mobile terminal. Each mobile terminal regards only the RAB at a location allocated to itself as valid information. The RAB is transmitted every frame and can be updated at a predetermined period. It is shown in FIG. 2 that the update period of the RAB is one frame.

When each mobile terminal receives the RAB from the base station, the mobile station determines a data rate with which data is to be transmitted during the frame at the next time point, and then, accordingly, performs reverse transmission through the R-PDCH. At this time, the status report information is transmitted to the base station through the R-RICH such that each mobile terminal can receive the RAB for the next frames. Although the RAB and the status report information are updated every frame in this embodiment, they can be updated every two or more frames.

Operation of Mobile Terminal

The operation performed in the mobile terminal according to the above description will now be described. The mobile terminal transmits the reverse traffic over the R-PDCH during every frame and informs the base station of the data rate used in the R-PDCH through the R-RICH. Also, the status report information is transmitted during every frame through the R-RICH or the R-SRCH. The same status report information is repeatedly transmitted during the update period of the status report information. The mobile terminal receives the RAB from the base station through the F-RRCCH during every frame. The same RAB is transmitted from the base station during the RAB update period. The mobile terminal changes the reverse data rate at a boundary of the RAB update period based on a value of the RAB transmitted during the RAB update period.

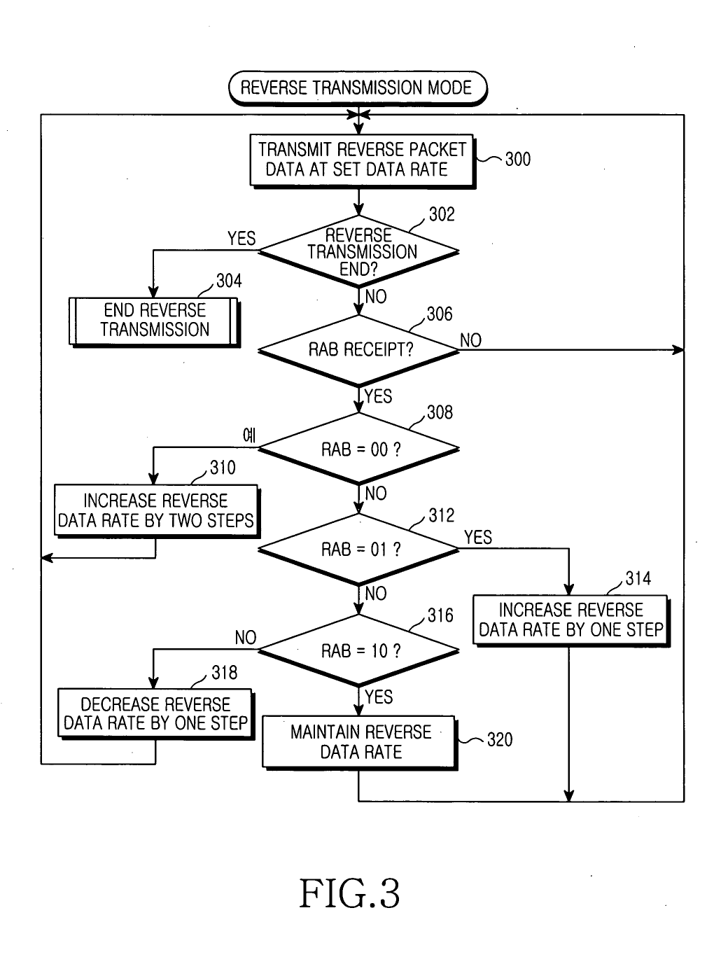

A control process when the reverse data rate is changed according to the RAB consisting of 2 bits received at the mobile terminal will now be described. FIG. 3 is a flow chart illustrating a process for changing the reverse data rate at the time for receiving the RAB in the mobile communication system in accordance with an embodiment of the present invention.

The mobile terminal will be described in the course of performing a reverse transmission mode. The description of signaling for the reverse transmission is omitted for the purpose of brevity. At step 300, the mobile terminal performs the reverse packet data transmission at a packet data rate set according to an agreement with the base station. In general, an initial data rate is set to the minimal data rate. At step 302, the mobile terminal determines if it is necessary to end the reverse data transmission. As a result of the determination in step 302, if it is necessary to end the reverse data transmission, at step 304, the mobile terminal performs the processes for ending the reverse data transmission.

If it is not necessary to end the reverse data transmission, the mobile terminal determines at step 306 whether the RAB is received through the F-RRCCH. As a result of the determination in step 306, if the RAB is received through the F-RRCCH, the process proceeds to step 308, but, otherwise, the reverse data transmission at step 300 continues to be performed. The mobile terminal determines at step 308 whether the received RAB has: a value “00”. Since the RAB consists of 2 bits in this embodiment, FIG. 3 is a flow chart illustrates the case (1) outlined in the above Section <Reverse Activity Bits>. When the RAB of “00” is received, the mobile terminal increases the reverse data rate by two steps at step 310. Here, the step of the reverse data rate can be explained as follows. The reverse packet data rate has predetermined values, for example, “0/9.6/19.2/38.4/76.8/153.6 kbps . . . ”. For example, if a current packet data rate is 9.6 kbps, increasing by two steps means that the current packet data rate is increased to 38.4 kbps. In this way, after the reverse packet data rate is increased, the reverse packet data transmission is performed at the predetermined data rate at step 300.

As a result of the determination in step 308, if the received RAB does not have the value “00”, the mobile terminal determines at step 312 whether the received RAB has a value “01”. As a result of the determination in step 312, if the received RAB has the value “01”, the mobile terminal increases the reverse packet data rate by one step at step 314. In this example, if a current packet data rate is 9.6 kbps, increasing by one step means that the current packet data rate is increased to 19.2 kbps. In this way, after the reverse packet data rate is increased at step 314, the reverse packet data transmission is performed at the predetermined data rate at step 300.

In addition, as a result of the determination in step 312, if the received RAB does not have the value “1”, the mobile terminal determines at step 316 whether the received RAB has a value “10”. As a result of the determination in step 316, if the received RAB has the value “10”, the mobile terminal maintains the reverse packet data rate at step 320. The reverse packet data transmission is performed at the predetermined data rate at step 300 while maintaining the current set data rate. However, as a result of the determination in step 316, if the received RAB does not have the value “10”, it has a value “11’. In this case, after decreasing the reverse packet data rate by one step at step 318, the mobile terminal performs the reverse packet data transmission at the predetermined data rate at step 300. In this way, the mobile terminal changes the width of the variation of the data rate not by one step, but by two steps or one step as required.

This allows the base station to adjust for the interference and capacity variation of the base station. In addition, the data can be transmitted with improved probability of success owing to swift disposal of the base station.

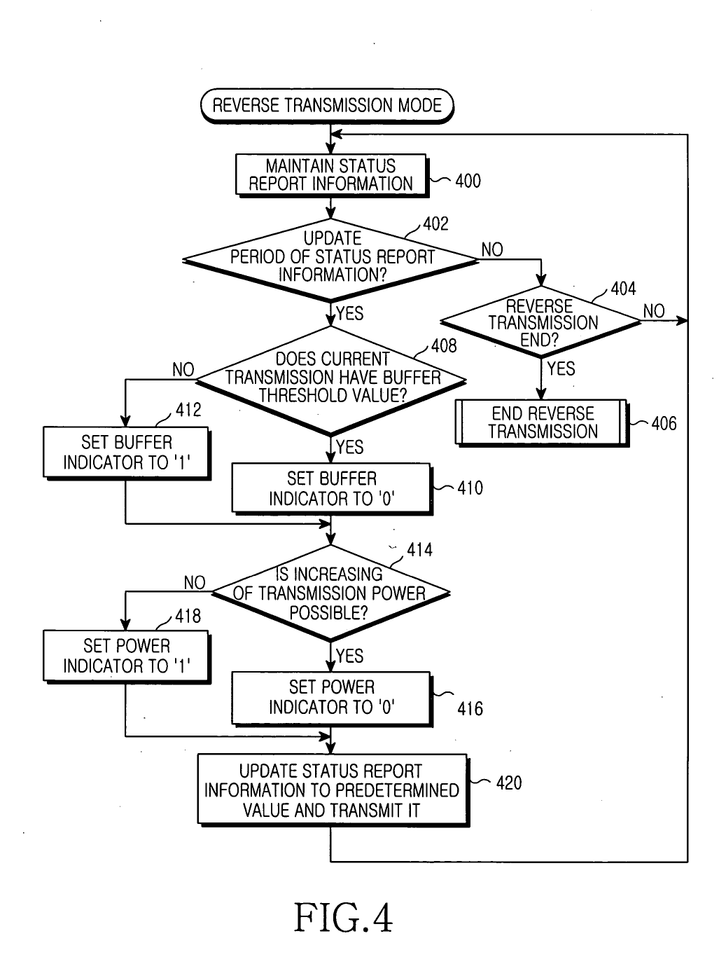

In FIG. 3, the status report information of the mobile terminal was not considered. Only the change of the data rate of the mobile terminal was considered in FIG. 3. A process for generating and reporting the status report information of the mobile terminal will now be described with reference to FIG. 4.

FIG. 4 is a flow chart illustrating a process for generating the status report information of the mobile terminal and transmitting the information in the reverse direction in accordance with the embodiment of the present invention. In the following description in conjunction with FIG. 4, the status report information will be described taking into consideration only two of the five factors described in the section Status Report Information.

It is assumed in FIG. 4 that the reverse transmission mode is performed. The description of signaling for the reverse transmission is omitted for the purpose of brevity. The mobile terminal maintains the status report information transmitted to the base station in the reverse transmission mode. It is determined at step 402 if a status report update period arrives. Although the status report update period is set to one frame in this embodiment of the present invention, it can be set to two or more frames. When the status report update period arrives, the mobile terminal proceeds to step 408. When the status report update period does not arrive, the mobile terminal determines at step 404 if it is necessary to end the reverse data transmission. As a result of the determination in step 404, if it is necessary to end the reverse data transmission, at step 406, the mobile terminal performs processes for ending the reverse data transmission. If it is not necessary to end the reverse data transmission, the status report information is maintained at step 400.

The mobile terminal determines at step 408 if a current transmission buffer has a value greater than a threshold value. The threshold value can be set to a predetermined value, as described above. Alternatively, the threshold value can be variably set based on the QoS of packet data to be transmitted. In the description, setting of the threshold value of the packet data will not be described in detail. As a result of the determination in step 408, if the current transmission buffer has a value greater than the threshold value, the mobile terminal set the buffer indicator to ‘0’ at step 410. If the current transmission buffer has a value less than the threshold value, the mobile terminal sets the buffer indicator to ‘1’ at step 412.

After setting the buffer indicator at step 410 or 412, the mobile terminal determines at step 414 if transmission power can be increased, that is, if the packet data can be transmitted even when current transmission power should be transmitted at higher power level by increasing the data rate. At this time, in the case where the increase of the transmission power is expressed by only one bit, only the increase or decrease of the data rate can be represented. In the case where the increase of the transmission power is expressed by two or more bits, a degree of change in the data rate can also be represented. The data rate can be increased in multiple steps, for example, one step, two steps, etc. However, since the flow chart becomes complicated if these multiple steps are considered, a case where the increase of the data rate is expressed by one bit will be described.

As a result of the determination in step 414, if it is possible to increase the transmission power, the mobile terminal sets the power indicator to ‘0’ at step 416. However, as a result of the determination in step 414, if it is impossible to increase the transmission power, the mobile terminal sets the power indicator to ‘1’ at step 418. After setting the power indicator at step 416 or 418, the mobile terminal updates the status report information with a value set at step 410 or 412 and a value set at step 416 or 418. When the status report information is updated, the mobile terminal transmits the updated status report information to the base station through the R-RICH or R-SRCH and returns to step 400 to maintain the status report information.

By transmitting the state of the mobile terminal to the base station, the base station can set the RAB for the data rate control of the packet data taking into consideration the state of the mobile terminal, and can properly maintain throughput of the reverse transmission channels and the capacity of the system.

As apparent from the above description, the mobile terminal transmits the status report information to the base station, and accordingly, the base station can increase efficiency of the reverse transmission by controlling the reverse data rate of the mobile terminal by one step, two steps or more steps. In addition, the capacity of the system can be properly maintained. Furthermore, the base station can quickly adjust to a variation of interference between radio channels and the data can be transmitted with improved probability of success owing to swift disposal of the base station.

Although the preferred embodiments of the present invention have been disclosed for illustrative purposes, those skilled in the art will appreciate that various modifications, additions and substitutions are possible, without departing from the scope of the invention. Therefore, the present invention is not limited to the above-described embodiments and drawings.

What is claimed is:

1. A method for controlling a reverse data rate of packet data in a mobile terminal of a mobile communication system, the method comprising the steps of:
a) determining and updating the status of reverse data rate control factors of the mobile terminal; and
b) transmitting status report information in a reverse direction through predetermined channels, the status report information based on the updated factors.

2. The method as set forth in claim 1, wherein the reverse data rate control factors include at least one of a buffer indicator indicating an amount of data stored in a buffer of the mobile terminal, a power indicator indicating an amount of available power of the mobile terminal, a rate request indicator indicating a reverse data rate required by the mobile terminal, a rate limit indicator indicating if a current data rate of the mobile terminal corresponds to a data rate of a predetermined limit value, and a multiple control indicator indicating if a data rate of the mobile terminal is controlled by two or more base stations.

3. The method as set forth in claim 1, wherein the reverse data rate control factors include a power indicator, an increase data rate change indicator, and if the data rate can be increased, the power indicator indicates the number of steps in increasing of the current data rate.

4. The method as set forth in claim 1, wherein the reverse data rate control factors include a buffer indicator, and wherein it is determined if increasing, decreasing, or maintaining of the data rate is required based on a value of a current buffer state of the mobile terminal, and when an increase or decrease of the data rate is required, the buffer indicator indicates the number of steps to increase or decrease the data rate.

5. The method as set forth in claim 1, wherein the reverse data rate control factors include a power indicator and a buffer indicator, the power indicator indicates the number of steps to increase of current data rate when increasing of the current data rate is possible, and the buffer indicator indicates if an increase or decrease of the data rate is required and the number of steps to increase or decrease the data rate based on a value of a current buffer state of the mobile terminal, the power indicator and the buffer indicator being transmitted together.

6. The method as set forth in claim 1, wherein a channel for transmitting the status report information is transmitted over a reverse rate indicator channel.

7. The method as set forth in claim 1, wherein a channel for transmitting the status report information is transmitted over a reverse status report channel.

8. The method as set forth in claim 1, wherein the reverse data rate control factors include a buffer indicator indicating the amount of data to be transmitted in a reverse direction.

9. The method as set forth in claim 8, wherein the buffer indicator indicates an increase or decrease tendency based on the data stored in a buffer.

10. A method for providing information for reverse data rate control of packet data and determining a data rate in a mobile terminal of a mobile communication system the method comprising the steps of:
checking and updating the status of reverse data rate control factors of the mobile terminal;
transmitting status report information in a reverse direction through predetermined channels the status report information being configured by the updated factors;
receiving reverse activity bits of the mobile terminal determined based on the status report information; and
determining a current data rate base on the received reverse activity bits.

11. The method as set forth in claim 10, wherein the reverse activity bits are information to be determined based on the status report information and the channel and system states.

12. An apparatus for determining a reverse data rate of packet data in a mobile terminal of a mobile communication system the apparatus comprising:
means for determining and updating the status of reverse data rate control factors of the mobile terminal;
means for transmitting stats report information in a reverse direction through predetermined channels, the status report information based on the updated factors;
means for receiving reverse activity bits received from the base station; and
means for determining a current data rate based on the received reverse activity bits.

13. The apparatus as set forth in claim 12, wherein the reverse data rate control factors include at least one of a buffer indicator indicating an amount if data stored in a buffer of the mobile terminal, a power indicator indicating an amount of available power of the mobile terminal, a rate request indicator indicating a reverse data rate required by the mobile terminal, a rate limit indicator indicating if a current data rate of the mobile terminal corresponds to a data rate of a predetermined limit value, and a multiple control indicator indicating if a data rate of the mobile terminal is controlled by two or more base stations.

14. The apparatus as set forth in claim 12, wherein the reverse data rate control factors include a power indicator and a buffer indicator, the power indicator indicates the number of steps to increase current data rate when increasing of the current data rate is possible, and the buffer indicator indicates if an increase or decrease of the data rate is required and the number of steps to increase or decrease the data rate based on a value of a current buffer state of the mobile terminal, the power indicator and the buffer indicator being transmitted together.

15. The apparatus as set forth in claim 12, wherein a channel for transmitting the status report information is transmitted over a reverse rate indicator channel.

16. The apparatus as set forth in claim 12, wherein a channel for transmitting a status report information is transmitted over a reverse status report channel.

17. The apparatus as set forth in claim 12, wherein the reverse activity bits are information to be determined based on the status report information and the channel and system states.

18. A method for determining reverse activity bits of a mobile terminal in a base station of a mobile communication system, the method comprising the steps of:
receiving status report information including reverse data rate control factors from the mobile terminal; and
determining reverse activity bits of the mobile terminal based on the received status report information and transmitting the determined reverse activity bits of the mobile terminal.

19. The method as set forth in claim 18, wherein the reverse data rate control factors consist of two or more transmission bits.

20. The method as set forth in claim 18, wherein, the status report information includes at least one of a buffer indicating an amount of data stored in a buffer of the mobile terminal, a power indicator indicating an amount available power of the mobile terminal, a rate request indicator indicating a reverse data rate required by the mobile terminal, a rate limit indicator indicating if a current data rate of the mobile terminal corresponds to a data rate of a predetermined limit value, and a multiple control indicator indicating if a data rate of the mobile terminal is controlled by two or more base stations.

21. The method as set forth in claim 18, wherein the reverse data rate control factors include a power indicator and a buffer indicator, the power indicator indicates the number of steps to increase current data rate when increasing of the current data rate is possible, and the buffer indicator indicates if an increase or decrease of the data rate is required and the number of steps to increase or decrease the date rate based on a value of a current buffer state of the mobile terminal, the power indicator and the buffer indicator being transmitted together.

22. The method as set forth in claim 18, wherein a channel for transmitting the status report information is transmitted to over a reverse rate indicator channel.

23. The method as set forth in claim 18, wherein a channel for transmitting the status report information is transmitted over a reverse status report channel.

24. The method as set forth in claim 18, wherein the reverse activity bits are information to be determined based on the status report information and the channel and system state.

25. An apparatus for determining reverse activity bits of a mobile terminal in a base station of a mobile communication system, the apparatus comprising;
means for receiving status report information including reverse data rate control factors from the mobile terminal; and
means for determining reverse activity bits of the mobile terminal based on the received status report information and transmitting the determined reverse activity bits of the mobile terminal.

26. The apparatus as set forth in claim 25, wherein the reverse data rate control factors consist of two or more transmission bits.

27. The apparatus as set forth in claim 25, wherein the status report information includes at least one of a buffer indicator indicating an amount of data stored in a buffer of the mobile terminal, a power indicator indicating an amount of available power of the mobile terminal, a rate request indicator indicating a reverse data rate required be the mobile terminal, a rate limit indicator indicating if a current date rate of the mobile terminal corresponds to a data rate of a predetermined limit value, and a, multiple control indicator indicating if a data rate of the mobile terminal is controlled by two or more base stations.

28. The apparatus as set forth in claim 25, wherein the reverse data rate control factors include a power indicator and a buffer indicator, the power indicator indicates the number of steps to increase of current data rate when increasing of the current data is possible, and the buffer indicator indicates if an increase or decrease of the data rate is required and the number of steps to increase or decrease the data rate based on a value of a current buffer state of the mobile terminal, the power indicator and the buffer indicator being transmitted together.

29. The apparatus as set forth in claim 25, wherein a channel for transmitting the status report information is transmitted over a reverse rate indicator channel.

30. The apparatus as set forth in claim 25, wherein a channel for transmitting the status report information is transmitted over a reverse status report channel.

31. The apparatus as set forth in claim 25, wherein the reverse activity bits are information to be determined based on the status report information and the channel and system states.

32. A method for controlling a reverse data rate of packet data in a mobile communication system including mobile terminals and base stations, the method comprising the steps of:
a) determining and updating by each of the mobile terminals the status of reverse data rate control factors of each mobile terminal, and transmitting status report information in a reverse direction over predetermined channels, the status report information being configured by the updated factors;
b) by each of the base stations, receiving the status report information, generating reverse activity information for each mobile terminal based on the received status report information and the channel and system states, and transmitting the generated reverse activity information to each mobile terminal; and
c) changing or maintaining by each of the mobile terminals a current data rate of each mobile terminal based on the reverse activity information.

33. The method as set forth in claim 32, wherein the reverse data rate control factors include at least one of a buffer indicator indicating a buffer of each mobile terminal, a power indicator indicating an amount of power of each mobile terminal, a rate request indicator indicating a reverse data rate required by each mobile terminal, a rate limit indicator indicating if a current data rate of each mobile terminal corresponds to a data rate of a predetermined limit value, and a multiple control indicator indicating if a data rate of the mobile terminal is controlled by two or more base stations.

34. The method as set forth in claim 32, wherein the reverse data rate control factors include a power indicator, and when an increase of a current data rate of the mobile terminal is possible, the power indicator indicates the number of steps to increase the current data rate.

35. The method as set forth in claim 32, wherein the reverse data rate control factors include a buffer indicator, and wherein it is determined if increasing, decreasing, or maintaining of the data rate is required based on a value of a current buffer state of the mobile terminal, and when an increase or a decrease of the data rate is required, the buffer indicator indicates the number of steps to increase or decrease the data rate.

36. The method as set forth in claim 32, wherein the reverse data rate control factors include a power indicator and a buffer indicator, the power indicator indicates the number of steps to increase a current data rate when increasing of the current data rate is possible, and the buffer indicator indicates if an increase, decrease, or maintaining of the data rate is required based on a value of a current buffer state of the mobile terminal, and indicates the number of steps to increase or decrease the data rate when an increase or decrease of the data rate is required, the power indicator and the buffer indicator being transmitted together.

37. The method as set forth in claim 32, wherein a channel for transmitting the status report information is transmitted over a reverse rate indicator channel.

38. The method as set forth in claim 32, wherein a channel for transmitting the status report information is transmitted over a reverse status report channel.

39. The method as set forth in claim 32, wherein the reverse activity information consists of at least two bits such that increasing or decreasing of the data rate of the mobile terminal is changed by one step, two steps or more steps.

40. An apparatus for controlling a reverse packet data rate in a mobile communication system including mobile terminals and base stations, wherein each of the mobile terminals determines and updates the status of reverse data rate control factors of each mobile terminal and transmits status report information in a reverse direction over predetermined channels, the status report information based on the updated factors,
wherein each of the base stations receives the status report information, generates reverse activity information for each mobile terminal based on the received status report information and the channel and system states, and transmits the generated reverse activity information to each mobile terminal.

41. An apparatus as set forth in claim 40, wherein each of the mobile terminals changes or maintains a current data rate based on the reverse activity information.

42. The apparatus as set forth in claim 40, wherein the reverse data rate control factors include at least one of a buffer indicator indicating an amount of data stored in a buffer of each mobile terminal, a power indicator indicating if an increasing in a power level of each mobile terminal is possible, a rate request indicator indicating a reverse data rate required by each mobile terminal, a rate limit indicator indicating if a current data rate of each mobile terminal corresponds to a data rate of a predetermined limit value, and a multiple control indicator indicating if the data rate of the mobile terminal is controlled by two or more base stations.

43. The apparatus as set forth in claim 40, wherein the reverse activity information consists of at least two bits such that increasing or decreasing of the data rate of the mobile terminal is changed by one step, two steps or more steps.

44. The apparatus as set forth in claim 40, wherein each of the base stations determines the reverse activity information for each mobile terminal and transmits the determined reverse activity information to each mobile terminal.
